(19) United States
(12) Patent Application Publication
(10) Pub. No.: US 2007/0261931 A1
(43) Pub. Date: Nov. 15, 2007

(54) Self-pumping hydropneumatic spring strut unit with internal level control

(75) Inventor: Hubert Beck, Eitorf (DE)

Correspondence Address: COHEN, PONTANI, LIEBERMAN & PAVANE, 551 FIFTH AVENUE, SUITE 1210, NEW YORK, NY, 10176, US

(73) Assignee: ZF Friedrichshafen AG, Friedrichshafen (DE)

(21) Appl. No.: 11/800,588

(22) Filed: May 7, 2007

(30) Foreign Application Priority Data
May 11, 2006 (DE) 10 2006 024 049.9

(51) Int. Cl. B60G 17/00

(52) U.S. Cl. 188/315; 267/64.17

(57) ABSTRACT

The strut unit includes a piston dividing an oil-filled working cylinder into first and second working spaces, wherein the second working space is connected to a high pressure chamber having a gas cushion; a hollow piston rod defining a pump cylinder; and a pump rod received in pump cylinder. The pump rod has a bore extending between its ends, and a deregulating opening which connects the bore to the second working space when the piston rod is extended. A first check valve permits flow from the low pressure chamber into the bore; a second check valve permits flow from the bore into the pump cylinder; and a third check valve permits flow from the pump cylinder to the second working space. The check valves are formed as substantially identical modules having cylindrical valve housings which can be press fit into a recess in either of two orientations.

### BACKGROUND OF THE INVENTION

1. Field of the Invention

The invention pertains to a self-pumping hydropneumatic spring strut unit with internal level control, especially for motor vehicles, including a piston dividing an oil-filled working cylinder into first and second working spaces, wherein the second working space is connected to a high pressure chamber having a gas cushion; a hollow piston rod defining a pump cylinder; and a pump rod received in pump cylinder. The pump rod has a bore extending between its ends, and a deregulating opening which connects the bore to the second working space when the piston rod is extended. A first check valve permits flow from the low pressure chamber into the bore; a second check valve permits flow from the bore into the pump cylinder; and a third check valve permits flow from the pump cylinder to the second working space.

2. Description of the Related Art

Self-pumping hydropneumatic spring strut units with internal level control are already known (e.g., U.S. Pat. No. 6,234,462 and DE 196 48 859 C2), in which the working cylinder is divided into two working spaces by a working piston carried by a hollow piston rod, and in which a piston pump is provided, which is driven by the spring-loaded movements and thus conveys oil from a low-pressure chamber into the working space connected to the high-pressure chamber. The piston pump includes of a pump cylinder, which is formed by a hollow piston rod, in the forward end of which the hollow pump rod, which carries a suction valve, travels. According to this prior art, a total of three spring-loaded check valves are provided, namely, an inlet valve, an outlet valve, and a drain valve. The inlet and outlet valves are necessary for the operation of the piston pump, and the drain valve is necessary for the throttled discharge of the damping medium when the load is removed from the vehicle body. The disadvantage here is that each of these valves is of a different design, which means that a large variety of different parts are required, which leads in turn to considerable logistic complexity and to a large amount of installation work. In particular, spring-loaded plate valves are so large that they cannot be installed in relatively small-diameter pump rods.

### SUMMARY OF THE INVENTION

An object of the invention is to provide a modular valve assembly (valve module) which can be used for all applications in the spring strut unit, which can be installed with ease, and which can be fabricated at low cost because of its simple design and especially because of the large number of units which can be produced.

According to the invention, at least two of the valves (drain valve, inlet valve, outlet valve) are formed by substantially identical modules.

It is advantageous for the valve modules to consist of a housing, a valve seat located in the housing, at least two guide webs, a valve body, and a closure produced for the valve body by a positive connection. It is advantageous to provide a simple check valve, which, in its basic version, consists of only two components and which, because of its uniform cylindrical external contour, can be installed on either side of the assembly in question.

According to another embodiment, at least three guide webs are provided to guide a ball, which serves as the valve body.

It is also possible for at least one valve to be provided with an always-open through-opening. This opening can be formed by a drain notch located in the valve seat.

According to an embodiment which is favorable in terms of manufacturing, the housings or the valves are pressed into the associated component. It is advantageous here for the pressed-in or merely pushed-in valves also to be peened to hold them in place in the associated component.

According to an essential feature, components of the housing are at least partially deformed to create the positive connection, where the deformed components of the housing are the upper areas of the guide webs.

According to additional embodiments, the valve body is either spring-loaded or rests by the force of gravity on the valve seat.

According to another embodiment, the guide webs are deformed to create the positive connection.

According to an elaboration of the invention, the valve body is held in place by a retaining element, which acts on the side of the valve body opposite the valve seat. It is advantageous for the retaining element to have at least one spring element by which it acts on the valve body.

According to an essential feature, the retaining element is provided with at least two elastic, radially inward-projecting spring elements.

According to an embodiment which is especially easy to fabricate, the retaining element is held in place in the housing by a positive connection.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a cross section through a self-pumping hydropneumatic spring strut unit;

FIG. 2 shows a cross section of a piston rod and a pump rod in isolation with a corresponding number of valves;

FIGS. 3-5 show valves in isolation;

FIGS. 6-10 show various ways in which a positive connection can be produced to hold the valve body according to FIGS. 3-6 in place; and

FIGS. 11-13 show cross sections of an additional variant of a check valve, where the valve body is held in place by a retaining element.

### DETAILED DESCRIPTION OF THE PRESENTLY PREFERRED EMBODIMENTS

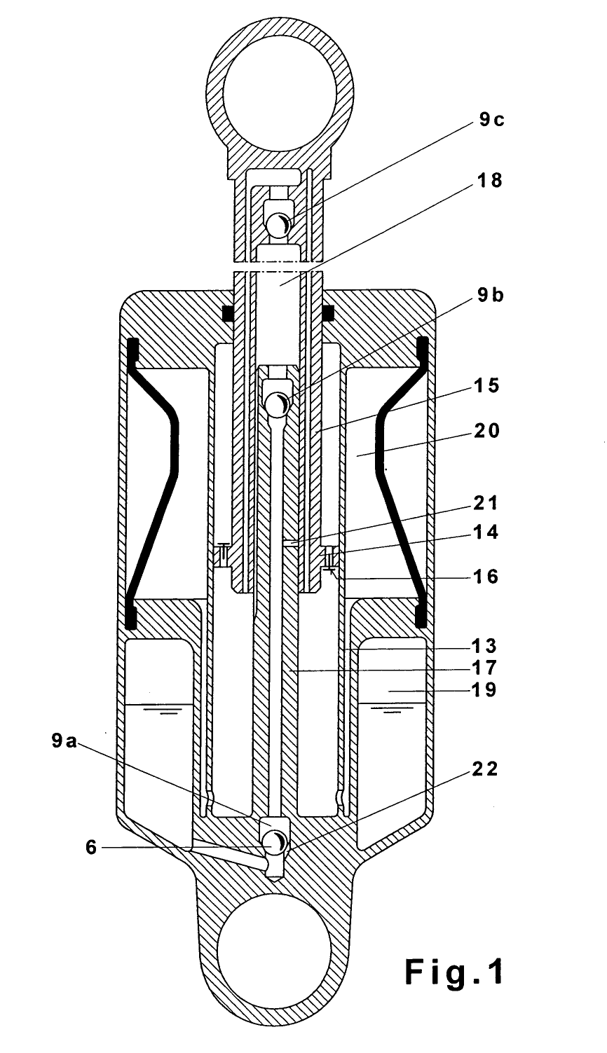

The spring strut unit for motor vehicles shown in FIG. 1 includes the working cylinder 13, in which a piston 14, mounted on the end of a piston rod 15, slides back and forth. The working cylinder 13 is sealed off appropriately at both ends and is fastened to the axle of a vehicle by appropriate means (not shown). The piston rod 15 is fastened to the vehicle body. The damping forces are generated by the damping valves 16 as the vehicle is being driven.

The spring strut unit according to FIG. 1 has an oil pump, which includes a pump rod 17 and the pump cylinder 18, formed by the hollow piston rod 15. The movements of the vehicle axle caused by irregularities in the road actuate this oil pump, which continually conveys oil, controlled by the first check valve 9a and the second check valve or suction valve 9b, out of the low-pressure chamber 19 and into pump cylinder 18, then via the third check valve or outlet valve 9c into the working cylinder 13 and thus to the high-pressure chamber 20. As a result, the piston 14 and the piston rod 15 are pushed outward until the dynamic level control goes into action by way of a bypass. When the load on the system is removed, the deregulating opening 21 of the pump rod 17 is released, and the vehicle is deregulated again.

The function of the first check valve or drain valve 9a is essentially to open wide in the suction direction and to provide a throttling effect in the drain-out direction, so that the vehicle body will deregulate gently. The advantage of this valve is that, during the suction stroke, the drain notch 22 is opened by the rising valve body 6 and can thus be flushed free of dirt particles. This helps to prevent the danger of clogging at this narrow throttle point. Due to its size, the drain opening 16 does not act as a throttle, and is therefore not subject to the risk of clogging.

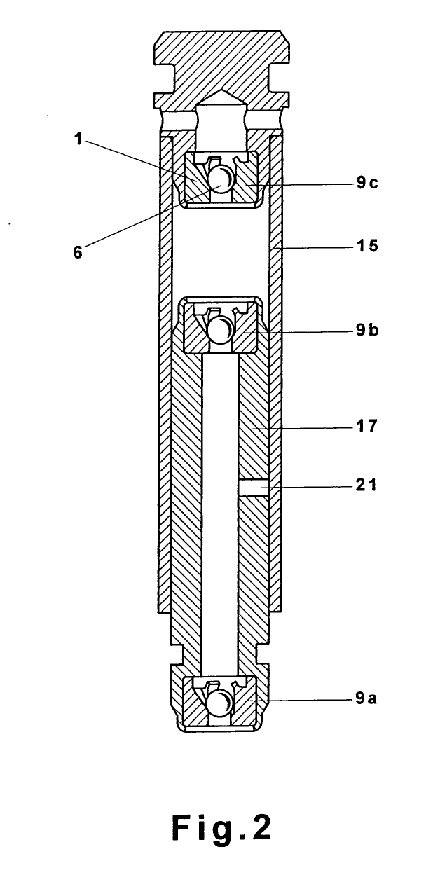

FIG. 2 shows a partial area of a piston rod 15, a pump rod 17, and the valves 9a, 9b, and 9c in isolation. In the pump rod 17, furthermore, the deregulating opening 21 is provided, which has already been described in conjunction with FIG. 1.

The valves 9a-9c are simple springless ball check valves, which consist merely of the housing 1 and the valve body 6, in this case in the form of a ball. Because of the simple, uniform cylindrical external contour of the housing 1, modules of this type can be easily installed easily into a recess in either of two axial orientations.

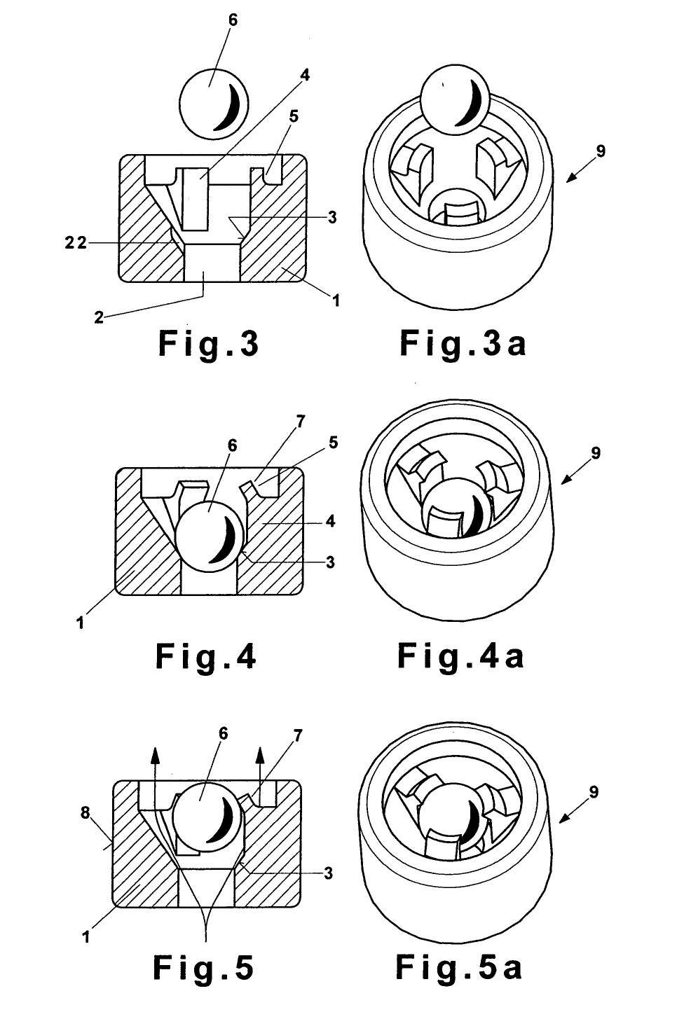

The valves of FIGS. 3-5 are of the same design; they can be provided with a drain notch 22, which is located in the sealing area of the valve body 6. The notch can also be produced afterwards, when the valve seat 3 is finished to exact size. To prevent confusion between parts, the valve housings 1 in question can carry visual identification codes. The housing 1 can be installed in the component in question by pressing it in, by pushing it in, or by peening it tightly in place, or by tightly pressing it in and then also peening it.

FIGS. 3 and 3a show a housing 1, made preferably of sintered iron, with a bore 2, through which the fluid medium arrives, and a following valve seat 3. The interior of the housing 1 is provided with three guide webs 4, the upper area 5 of which can have different contours. The valve body 6 in the form of a ball can be easily introduced into the housing 1, since appropriate guide play is provided between it and the guide webs 4.

FIGS. 4 and 4a show the valve body 6 again as a ball, the valve body 6 now resting by the force of gravity on the valve seat 3 of the housing 1. The linear contact between the valve body 6 and the housing 1 is situated below but still near the equator of the ball of the valve body 6. Peening the upper area of the guide webs 5 to form peened areas 7 ensures that the valve body remains captive. The diagram of FIG. 4 shows the valve in the closed position.

FIG. 5 shows a valve in the position which allows the fluid medium to pass through. The valve body 6 in the form of a ball first travels a certain distance in the opening direction and then comes to rest against the peened areas 7; here the valve body 6 makes contact with the housing 1 above but nevertheless near the equator of the ball.

The uniform cylindrical external surface 8 of the housing 1 makes it possible to install valves of this type from both directions. To optimize the sealing action of the valve, the valve seat 3 can be finished to exact size and thus smoothed. During this same work step, the dimensions of the cylindrical external surface 8 of the housing 1 can also be precisely adjusted.

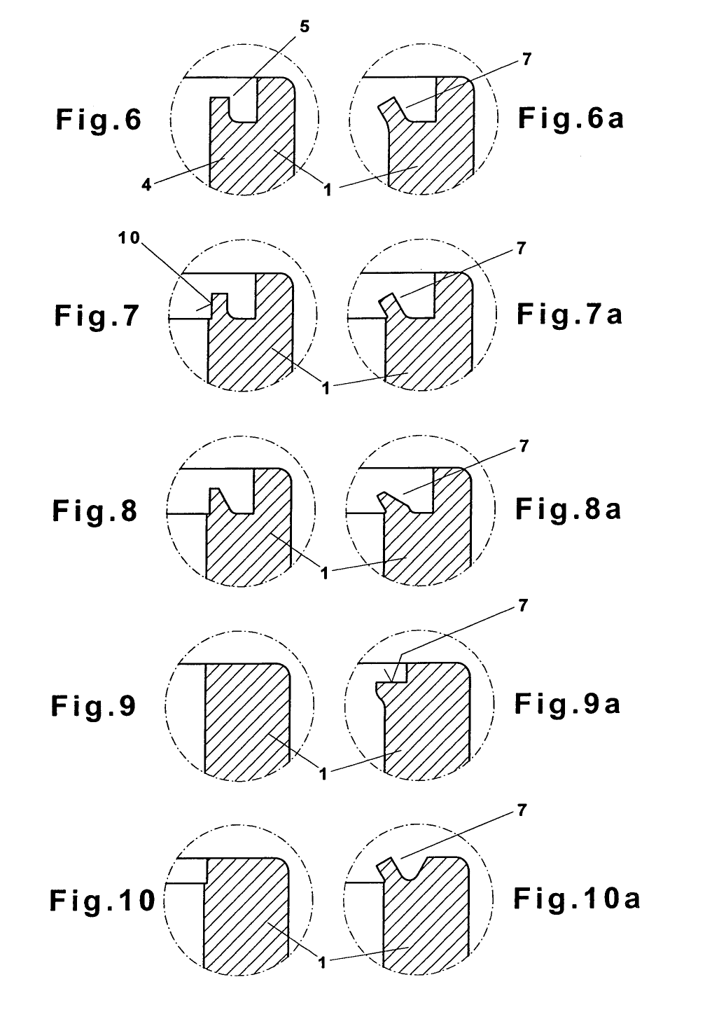

FIGS. 6-10 show the most important ways in which the peened areas 7 in the upper areas 5 of the guide webs 4 can be produced.

FIG. 6 shows the upper area 5 as a thin, elevated, segment-shaped guide web 4, which, as FIG. 6a shows, is provided with a peened area 7 and thus deformed so that it extends radially inward at an angle toward the center.

FIG. 7 shows that the web 7 has a shoulder 10, which allows the bending to occur precisely at this point.

FIGS. 8 and 8a shows that the guide webs 4 are bent in the area where the greatest amount of material is present. In the case of sintered metal, a bend located in the area of greatest material accumulation prevents the material from fracturing, in that sintered material is relatively brittle.

FIGS. 9 and 10 show two different ways in which a peened area 7 can be produced. A blunt stamping end (FIG. 9) or a pointed stamping end (FIG. 10) of an appropriate tool is used here to drive the material of the housing 1 appropriately inward.

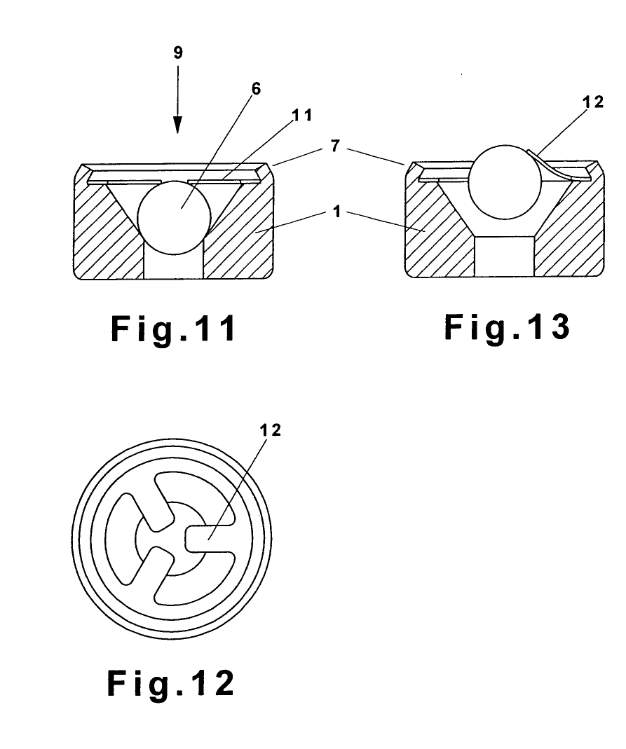

FIGS. 11-13 show another variant of a valve 9, in which the valve body 6 is held in place in the housing by a retaining element 11, where the retaining element 11 is itself held in place in the housing 1 by a peened area 7. According to FIG. 12, which shows a plan view, the retaining element 11 can be provided with a predetermined number of spring tongues 12, which exert an appropriate elastic pressure on the valve body 6, which, in this embodiment, is again designed as a ball.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A self-pumping hydropneumatic spring strut unit with internal level control, the unit comprising:
a compensating chamber divided into a high pressure chamber and a low pressure chamber, the high pressure chamber having a gas cushion which acts as a spring;
an oil-filled working cylinder in the compensating chamber;
a piston dividing the working cylinder into first and second working spaces, wherein the second working space is connected to the high pressure chamber;
a hollow piston rod connected to the piston and extending out of the working cylinder, the hollow piston rod defining therein a pump cylinder;
a pump rod having a proximal end fixed to the working cylinder, a distal end received in the pump cylinder, a bore extending between the ends, and a deregulating opening which connects the bore to the second working space as a function of the position of the piston in the working cylinder;
a first check valve at the proximal end of the pump rod, the first check valve permitting flow from the low pressure chamber into the bore;
a second check valve near the distal end of the pump rod, the second check valve permitting flow from the bore into the pump cylinder; and
a third check valve at the end of the pump cylinder, the third check valve permitting flow from the pump cylinder into the second working space;
wherein at least two of said check valves are formed by valve modules which are at least substantially identical.

2. The spring strut unit of claim 1 wherein each of said valve modules comprises a valve housing having a valve seat, a valve body received in said valve housing, and a closure for positively retaining the valve body in the valve housing.

3. The spring strut unit of claim 2 wherein said valve body comprises a ball.

4. The spring strut unit of claim 2 wherein said valve housing is formed with three guide webs for guiding said valve body onto said seat.

5. The spring strut unit of claim 2 wherein the valve seat of said first check valve is formed with a drain notch.

6. The spring strut unit of claim 2 wherein the valve housing can be pressed into a recess in either of two axially opposed orientations.

7. The spring strut unit of claim 6 wherein the valve housing is retained in the recess by peening.

8. The spring strut unit of claim 2 wherein the closure is formed by deforming the valve housing.

9. The spring strut unit of claim 4 wherein the guide webs have upper extensions which can be deformed to form said closure.

10. The spring strut unit of claim 2 wherein the valve body is urged toward the seat solely by gravity.

11. The spring strut unit of claim 2 wherein the closure comprises a retaining element which is fitted in said valve housing.

12. The spring strut unit of claim 11 wherein the retaining element comprises at least one spring element which urges said valve body toward said seat.

13. The spring strut unit of claim 11 wherein the retaining element is held in said valve housing by peening.

14. The spring strut unit of claim 1 wherein the first working space is connected to the second working space by at least one damping valve in the piston.
